(19) United States
(12) Patent Application Publication
(10) Pub. No.: US 2015/0135827 A1
(43) Pub. Date: May 21, 2015

(54) Heated Antenna

(71) Applicant: VEGA Grieshaber KG, Wolfach (DE)

(72) Inventor: Joachim Benz, Hausach (DE)

(21) Appl. No.: 14/503,825

(22) Filed: Oct. 1, 2014

(30) Foreign Application Priority Data
Nov. 8, 2013 (DE) 10 2013 222 767.1
Sep. 23, 2014 (EP) 14 185 993.4

(51) Int. Cl. G01F 23/284; H01Q 19/06; H01Q 1/02

(52) U.S. Cl. CPC G01F 23/284; H01Q 1/02; H01Q 19/062
USPC 73/290 V

(57) ABSTRACT

The invention describes a fill level measuring device, comprising a microwave transceiver, an antenna connected to the microwave transceiver, which comprises an outlet opening for a targeted emission of microwave radiation as well as an antenna cover arranged at the outlet opening, which closes the outlet opening in a sealing fashion, with the fill level measuring device additionally comprising a heating device, by which the antenna cover can be heated to avoid the formation of condensate.

### CROSS REFERENCE TO RELATED APPLICATIONS

This patent application claims priority to German Patent Application 10 2013 222 767.1, filed on Nov. 8, 2013 and European Patent Application 14 185993.4, filed on Sep. 23, 2014.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

1. Field of the Invention

The present invention relates to a fill level measuring device, particularly a radar wave fill level measuring device for measuring the fill level in a container or for measuring the height of bulk goods in a container, with a sensor being embodied as a heated horn antenna or a parabolic antenna.

2. Background of the Invention

The current state of knowledge is as follows.

Sensors are known for measuring the fill level in a container, which is filled with a liquid or with bulk goods. The measuring of the fill level occurs here frequently via run time detection of high frequency signals, with the sensor being embodied as a horn antenna or a parabolic antenna.

Such fill level measuring devices may be used for measuring the fill level of liquids or for measuring the fill level of bulk goods or for determining the limit of liquids or bulk goods. The measurement occurs here frequently in containers which must be sealed airtight from the ambient atmosphere because they are pressurized or show atmospheres with high temperatures or because the fill level must be measured in the container using aggressive media. Containers or bunkers open to the atmosphere are also possible.

When measuring the fill levels using run time detection of high frequency signals the high frequency pulses are emitted by an antenna and reflected at the surface of a medium. The reflected high frequency pulses are received by the sensor. The distance of the sensor from the surface of the respective medium can be determined from the time difference between the transmission of the high frequency pulse and the reception of the reflected high frequency pulse. The high frequency pulses are located within the range of radar waves, thus the respective fill level measuring devices usually show a microwave transceiver, which emits microwave radiation in the C-band, the K-band, or the W-band. The antennas in this range are generally horn antennas or horn antennas coupled with parabolic antennas. The microwave transceiver generates the microwave radiation, which is then emitted by a hollow conductor and a horn antenna arranged at one end of the hollow conductor. The antenna is aligned to the interior of the container, in order to allow determining the fill level of the bulk good accepted by the container or the liquid accepted in the container.

Due to the fact that the antenna components must be protected from environmental influences, such as dust or condensation, the antenna of fill level measuring devices are generally provided with an antenna cover. The antenna cover shall on the one hand protect the antenna components from the container atmosphere and on the other hand avoid influencing the microwaves or radar signals emitted by the microwave transceiver to the extent possible.

In such antenna covers it is disadvantageous though that dust and condensate can precipitate on them, which when accumulated may lead to encrusting, and thus that the reference echo is damped and noise echoes may occur. This leads to the consequence that a determination or at least a sufficiently precise determination of the distance between the fill level measuring de-vice and the surface of the bulk goods or liquid to be measured is no longer possible.

The objective of the present invention is therefore to provide a fill level measuring device, which even in aggressive environmental atmospheres can be used reliably at all times for measuring the fill level.

This objective is attained in the device according to claim 1. Advantageous embodiments are disclosed in the dependent claims.

### BRIEF SUMMARY OF THE INVENTION

In a preferred embodiment, a fill level measuring device, comprising a microwave transceiver, an antenna connected to the microwave transceiver, which comprises an outlet opening for a targeted emitting of microwave radiation, and an antenna cover arranged at the outlet opening and closing the outlet opening in a sealing fashion, wherein the fill level measuring device additionally comprises a heating device by which the antenna cover can be heated.

In another preferred embodiment, the fill level measuring device described herein, wherein the heating device is a resistance heater arranged at an antenna cover, which comprises at least a two-core supply line for the electric connection of the resistance heater to a power source, with the resistance heater being arranged at the antenna cover such that it heats the antenna cover directly via thermal conductivity when it is connected to a live power source.

In another preferred embodiment, the fill level measuring device described herein, wherein the antenna cover comprises a surface formed outside the antenna in a conical fashion, with the surface of the antenna cover preferably being fluid repellent.

In another preferred embodiment, the fill level measuring device described herein, wherein the antenna cover represents an antenna lens for bundling the microwave radiation.

In another preferred embodiment, the fill level measuring device described herein, wherein the resistance heater is arranged extending meandering at or in the antenna cover.

In another preferred embodiment, the fill level measuring device described herein, wherein the resistance heater comprises longitudinal sections arranged parallel in reference to each other, which are connected to each other at their ends via lateral sections, with the longitudinal sections extending straight-lined and show at least twice the length, preferably four times the length of the lateral sections.

In another preferred embodiment, the fill level measuring device described herein, wherein the resistance heater is aligned in reference to the antenna such that the longitudinal sections of the resistance heater are arranged perpendicular in reference to the polarization of the microwave radiation.

In another preferred embodiment, the fill level measuring device described herein, wherein the antenna is made from a metal coated plastic.

In another preferred embodiment, the fill level measuring device described herein, wherein the antenna cover is made from a non-conductive plastic, preferably PTFE.

In another preferred embodiment, the fill level measuring device described herein, wherein the antenna cover is fastened with a metal ring at the end of the antenna, preferably via a screw connection.

In another preferred embodiment, the fill level measuring device described herein, wherein the fill level measuring device comprises a device flange for sealing the interior chamber of the container from an exterior chamber of the container, with the device flange comprising a bore channel with a first end and a second end, preferably in the form of a bore tunnel, with its first end being open and with its second end being closed in a sealing fashion by a screw-connected cover fastened at the device flange, which shows an electric passage.

In another preferred embodiment, the fill level measuring device described herein, wherein a supply line is guided through a sealing passage which separates the atmosphere inside the antenna from the atmosphere surrounding the antenna, with the sealing passage being arranged preferably at the metal ring.

In another preferred embodiment, the fill level measuring device described herein, wherein a supply line is arranged in the bore channel and electrically connected to the sealing screw connection or is guided through the sealing screw connection.

In another preferred embodiment, the fill level measuring device described herein, further comprising a control unit for controlling the heating device, which is electrically connected to the supply line.

In another preferred embodiment, the fill level measuring device described herein, wherein the resistance heater is molded with the antenna cover or is adhered on the antenna cover, with the resistance heater preferably representing a resistance wire.

In another preferred embodiment, the fill level measuring device described herein, wherein the antenna is a horn antenna or a parabolic antenna.

In another preferred embodiment, the fill level measuring device described herein, wherein the metal ring is a part of the device flange or is embodied in one piece with said device flange.

In another preferred embodiment, the fill level measuring device described herein, wherein the antenna cover comprises a temperature measuring means and/or a humidity measuring means and/or a means for detecting adhering substances on the antenna cover, and the control unit using the measurements provided by the temperature measuring means and/or the humidity measuring means and/or the means for detecting substances adhering to control the energy to be supplied to the heating device.

In another preferred embodiment, the fill level measuring device described herein, wherein energy is supplied to the heating in a time-controlled fashion.

In another preferred embodiment, the fill level measuring device described herein, wherein the capacity of the energy supplied to the heating device is determined depending on the temperature measured at the antenna cover and/or depending on the humidity measured at the antenna cover and/or depending on the components adhering at the antenna cover and/or depending on other parameters.

### BRIEF DESCRIPTION OF THE DRAWINGS

FIG. 1 is a line drawing evidencing a cross-section through a first exemplary embodiment of a fill level measuring device,

FIG. 2 is a line drawing evidencing a cross-section through another exemplary embodiment of a fill level measuring device,

FIG. 3 is a line drawing evidencing an arrangement of a heating device on an antenna cover.

### DETAILED DESCRIPTION OF THE INVENTION

The invention provides a fill level measuring device, which comprises a microwave transceiver, an antenna connected to the microwave transceiver, comprising an outlet opening for a targeted emission of microwave radiation, as well as an antenna cover, arranged at the outlet opening and closing the outlet opening in a sealing fashion. Ac-cording to the invention the fill level measuring device additionally comprises a heating de-vice, by which the antenna cover can be heated. This way the formation of condensate on the antenna is prevented and the soiling is reduced when dust develops so that in combination with the condensation, encrusting can no longer develop. This way, both noise echoes as well as the damping of the reference echo is reduced, which ensures a reliable measurement of the fill level even in aggressive and condensate forming environmental atmospheres.

The heating device is advantageously a resistance heater arranged at the antenna cover. It preferably shows at least one two-core supply line for the electric connection of the resistance heater comprising a power source, with the resistance heater being arranged at an antenna cover such that it directly heats the antenna cover via thermal conductivity, when it is connected to a live power source. A resistance heater, which is arranged directly at the antenna cover and is capable to directly heat it, can be designed with relatively simple means.

The antenna cover preferably shows a conically formed surface outside the antenna, advantageously a surface which is fluid repellant. The advantage of an antenna cover formed this way is the fact that during any formation of liquid condensation the condensate can drain down-wards and drip off.

The antenna cover may for example represent an antenna lens for bundling the microwave radiation. This way the focusing and precise alignment of the microwave signals can be ensured with simple mechanical means.

In order to ensure that the surface of the antenna cover pointing in the measuring direction is heated evenly, the resistance heater is arranged extending meandering at or in the antenna cover.

The resistance heater preferably comprises two longitudinal sections arranged parallel in reference to each other, which are connected at their ends with lateral sections, with the longitudinal sections extending straight-lined and show at least twice the length, preferably at least four times the length of the lateral sections. The resistance heater can then be aligned in reference to the antenna such that the longitudinal sections of the resistance heater are arranged perpendicular in reference to the polarization of the microwave radiation. This way the resistance heater can be aligned such that the emitted microwave radiation is damped as little as possible. On the other hand, the resistance heater can simultaneously act as a polarization for echo signals, so that for example the parasitic microwave radiation reflected at the container walls and altered in the direction of polarization is at least partially suppressed.

A low-cost and weight reduced embodiment of the antenna can be realized here such that the antenna is produced from a plastic coated with metal.

The antenna cover preferably comprises a non-conductive plastic, particularly preferred PTFE. Such a plastic is advantageous in that it dampens the microwave signal to only a minor extent.

The antenna cover is preferably fastened with a metallic ring at the end of the antenna, prefer-ably via a screw connection. This metallic ring can advantageously also be embodied as a part of a device flange or formed as a device flange, which can be arranged at the container in a sealing fashion. A sealing, preferably compression proof sealing connection is particularly required when the atmosphere inside the inner chamber of the container shall be securely separated from the atmosphere outside the inner chamber of the container. This way, a simple and sealing fastening of the antenna cover at the antenna can be realized. Such a metal ring stabilizes the connection between the antenna cover and the antenna. When the metal ring is embodied as a part of the device flange or represents the device flange, on the one hand the atmosphere of the inner chamber of the container can be separated from the atmosphere of the exterior chamber of the container, on the other hand the antenna cover can be fastened at the antenna in a sealing fashion, so that even any corrosion of the antenna by the material located in the container is effectively prevented.

The preferably compression proof, sealing separation between the interior chamber of the container and the exterior chamber of the container increases the security for bulk goods or liquids, which shall not come into contact with the exterior environment, so that they may not be contaminated for example, or that they cannot contaminate the environment. The containers subject to pressure or a vacuum, particularly those in which environmentally harmful or hazardous materials are located, mandatorily require a particularly good sealing between the interior chamber of the container and the exterior chamber of the container. However, good sealing between the interior chamber of the container and the interior of the antenna is here beneficial as well, in order on the one hand to prevent any corrosion of the antenna and on the other hand to render available a defined, homogenous dielectric inside the antenna element. The metal ring at the antenna cover can this way fulfill these tasks, in addition to a stabilizing effect.

In one advantageous embodiment the fill level measuring device comprises a device flange for sealing an inner chamber of a container from an exterior chamber of the container, with the device flange preferably comprising a bore channel, with its first end being open and its second end being closed with a screw connection, fastened at the device flange in a sealing fashion, with the sealing screw connection comprising an electric passage. This allows a compression tight electric passage of a heating wire supply line from the exterior chamber of the container into the interior chamber of the container so that the container atmosphere is prevented from reaching the environment. The supply line of the resistance heater is preferably arranged in a bore channel and electrically connected to the sealing screw connection or passed through the sealing screw connection. The sealing screw connection can here be embodied also as a plug-in connector, for example. The heating wire supply lines extend outside the waveguide antenna, not in its interior, and thus they cannot be compromised by an RF-signal traveling through the hollow conductor, for example microwave radiation emitted and/or received.

In one embodiment the supply line can additionally or alternatively comprise a sealing passage, which separates the atmosphere inside the antenna from the atmosphere surrounding the antenna. The supply line to the resistance heater is in this case guided through the sealing pas-sage, with the sealing passage being preferably arranged at the metal ring, thus a mechanically stable sealing passage is realized, so that the fill level measuring device is more robust. For measuring devices arranged outside and operating in the W-band such passages for the electric supply lines are usually not required.

The fill level measuring device can furthermore have a control unit for controlling the heating device, which is electrically connected to the supply line to the heating device. By controlling the heating device any overheating is prevented, allowing a more effective heating of the an-tenna cover with overall lower and optimized energy.

This way, in an advantageous embodiment of the invention the heating energy supplied to the heating device can be embodied in a time-controlled fashion. The decision regarding if and how much power shall be supplied to the heating device can be made dependent on additional parameters. The capacity of the energy supplied to the heating device may for example be supplied depending on the temperature measured at the antenna cover and/or depending on the humidity measured at the antenna cover and/or depending on the components adhering to the antenna cover and/or depending on other parameters, such as the air pressure or the consistency of the atmosphere surrounding the fill level measuring device, and subsequently sup-plied to the heating device.

For this purpose temperature sensors may be used, connected in a thermal fashion to the antenna cover and advantageously arranged thereat and/or fastened thereat. Additionally, humidity sensors arranged at the antenna cover and preferably arranged and fastened at the antenna cover may be used. The temperature and/or humidity values respectively measured regularly at the antenna cover can then preferably be transmitted to the control unit, which for ex-ample decides if the heating device is or is not switched on, or the amount of energy per time unit that is to be supplied to the heater.

In one embodiment a potential adherence at the antenna cover can be detected such that the emitted and/or received reflected microwave signal of the fill level measuring device is analyzed in more precisely and, depending on the result of this analysis, the heating device is switched on, and advantageously the heating energy supplied to the heating device or the electricity conducted through the heating device is determined. The measuring device can this way detect any adherence and, upon reaching a threshold or a characteristic and/or critical progression of the microwave signals, switch on the heater.

The fill level measuring device preferably comprises a control device, which controls the time during which energy is supplied to the heating device, with measurements, supplied and analyzed by the temperature measuring means and/or the humidity measuring means and/or the microwave signal emitted and/or reflected, being used to control the energy to be supplied in order to control the heating device. As soon as a predetermined threshold and/or a characteristic microwave signal progression is reached the heating device can be supplied with the necessary heating energy in order to remove the adherence again. This saves energy, because heating energy needs to be supplied to the heating device not continuously but only when required. After the adherence and/or the material condensed on the antenna cover has been re-moved the heating device can be shut off again.

The resistance heater can be adhered onto the antenna cover, for example. This represents an option to generate a full-area thermal contact between the resistance heater and the antenna cover. The heating energy can this way be effectively transferred through the solid body thermal conductor to the antenna cover and heat it. Preferably the resistance heater is however molded with the antenna cover, with it here beneficially being embodied as a resistance wire. The resistance heater can also be embodied as a linearly extending powder, sintered on the antenna cover, or as a conductor path vapor deposited on the antenna cover. In these cases as well a good thermal contact is ensured between the resistance heater and the antenna cover. It is ensured by adhering the resistance heater on the antenna cover, preferably on the side of the antenna cover facing away from the surface of the bulk goods or the surface of the liquid or by way of molding that a thermal conductivity as good as possible develops between the heater and the antenna cover and the heater windings are protected from corrosion.

The heating principle can be used flexibly both in a horn antenna as well as at the blister of a parabolic antenna, so that the antenna preferably is a horn antenna or a parabolic antenna.

The terms used in the following description, such as top, bottom, left, and right, and the like relate to the exemplary embodiments and shall not be considered restrictive, even when they relate to preferred embodiments. The terms microwave radiation, high-frequency radiation, and radar wave radiation are used equivalently for electromagnetic radiation in the range from 1 GHz to 1,000 GHz.

### DETAILED DESCRIPTION OF THE FIGURES

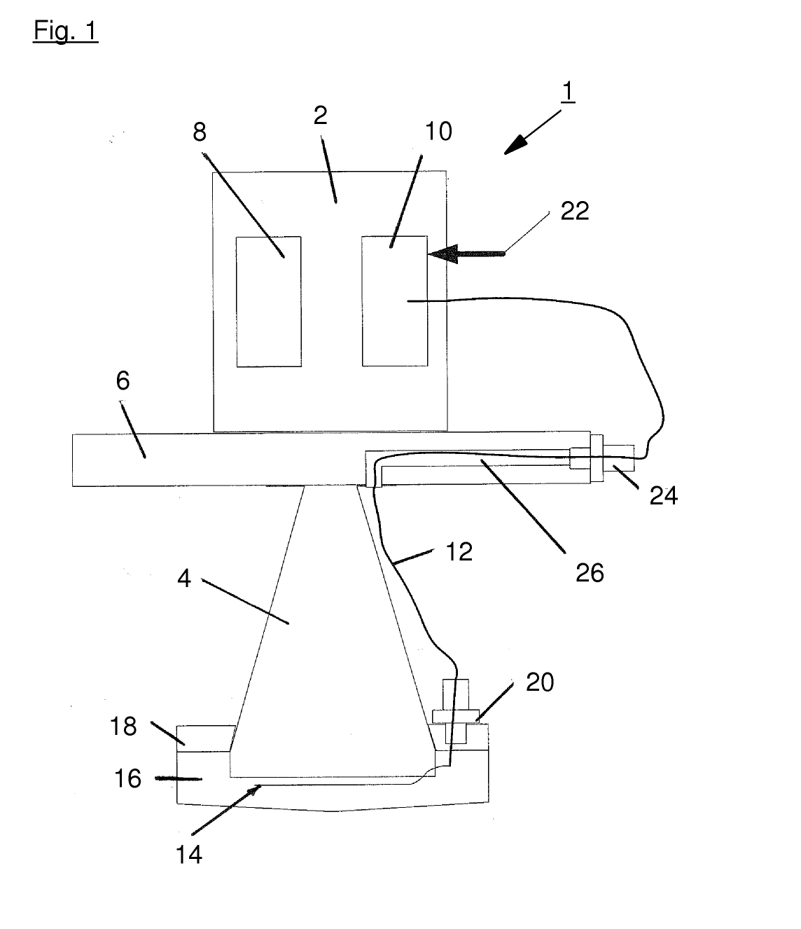

FIG. 1 shows a fill level measuring device 1, which comprises a sensor housing 2 connected to a horn antenna 4. A device flange 6 is arranged between the sensor housing 2 and the horn antenna 4 for a sealing placement of the fill level measuring device 1 onto a container, not shown. The sensor housing 2 includes a sensor electronic 8 as well as a control unit 10. The control unit 10 supplies via a heating connection line 12 a heating device 14, which is arranged at an antenna cover 16, which is fastened with a metallic ring 18 at the lower part of the horn antenna 4, or the radiation emitting part.

The heater connection line 12 is passed through a sealing passage 20 connected to the metal ring 18 and connected to the heating device 14. The heating connection line 12 is a supply line 12, which supplies the control power to the resistance heating device 14 provided by the control unit 10. The control unit 10 is here supplied by an energy supply 22 using a battery or an external power source. The supply line 12 is guided from the control unit 10 through a sealing screw connection 24 and a bore channel embodied as a bore tunnel 26 in the device flange 6 into the interior chamber of the container. The sealing screw connection 24 is fastened in a pressure-tight fashion at the device flange 6. The device flange 6 may be placed in a pressure-tight fashion on the container (not shown), which contains the liquid or the bulk goods.

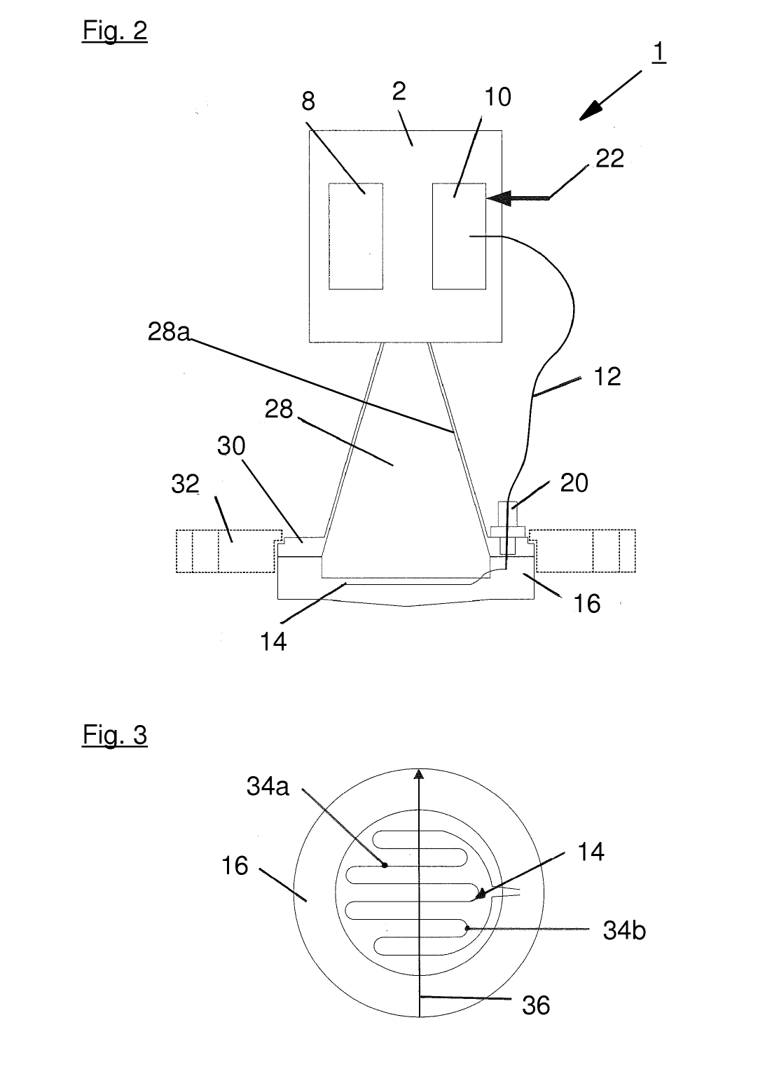

FIG. 2 shows another embodiment of the fill level measuring device 1. The control device 10 and the sensor housing 2 comprising the sensor electronic 8 are directly connected to a plastic horn antenna 28, which preferably shows a metal coating 28a at the inside. The supply line 12 connects the outlet of the control unit 10 to the input of the heating device 14, which is de-signed as a resistance heater in the antenna cover 16 embodied as antenna lens 16. The plastic horn antenna 28 comprises a metal coating 28a, which may be connected to a form 30, prefer-ably made from plastic or metal. The supply line 12 is guided through a sealing passage 20 arranged at the form 30 and connected to the heating device 14 below the sealing passage 20. The sealing passage 20, similar to the sealing screw connection 24 in FIG. 1 and the sealing passage 20 in FIG. 1, may represent a standard-PG-screw connection, for example. The control unit 10 serves for the constant heating of the antenna cover 16 to a temperature which reliably prevents any formation of condensate on the antenna cover 16 and/or on the antenna lens 16. The antenna lens 16 is additionally formed conically such that condensing material can drain downwards and drip off. The form 30 shows a recess for a collar flange 32 engaging, which is connected in a pressure-tight fashion to the container (not shown), which holds the bulk goods or the liquids, whose surface or volume shall be determined.

FIG. 3 shows a heating device 14, which is arranged in an antenna cover and/or antenna lens 16. The resistance heater 14 comprises several longitudinal sections 34a arranged parallel in reference to each other, which are connected to each other via lateral sections 34b. For example, the heating device 14 is molded in the antenna cover 16 so that a good thermal conductivity is achieved between the antenna cover 16 and the heating device 14. The antenna cover or the antenna lens 16 is arranged on the metal-coated plastic horn antenna 28, 28a such that the direction of polarization 36 of the microwave radiation emitted by the microwave generator (not shown) is arranged perpendicular in reference to the longitudinal sections 34a of the heating device 14.

The invention was explained in greater detail based on two exemplary embodiments, without being restricted thereto. One trained in the art knows numerous variations and embodiments of the device according to the invention without leaving the concept of the invention thereby.

### LIST OF REFERENCE NUMBERS

1 Fill level measuring device

2 Sensor housing

4 Horn antenna

6 Device flange

8 Sensor electronic

10 Control unit

12 Supply line, heating connection line

14 Heating device

16 Antenna cover, antenna lens

18 Metal ring

20 Sealing passage

22 Energy supply

24 Sealing screw connection

26 Bore channel, bore tunnel

28 Plastic horn antenna

28a Metal coating

30 Form

32 Collar flange

34a Longitudinal section

34b Lateral section

36 Direction of microwave polarization

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

We claim:

1. A fill level measuring device, comprising a microwave transceiver, an antenna connected to the microwave transceiver, which comprises an outlet opening for a targeted emitting of microwave radiation, and an antenna cover arranged at the outlet opening and closing the outlet opening in a sealing fashion, wherein the fill level measuring device additionally comprises a heating device by which the antenna cover can be heated.

2. The fill level measuring device of claim 1, wherein the heating device is a resistance heater arranged at an antenna cover, which comprises at least a two-core supply line for the electric connection of the resistance heater to a power source, with the resistance heater being arranged at the antenna cover such that it heats the antenna cover directly via thermal conductivity when it is connected to a live power source.

3. The fill level measuring device of claim 1, wherein the antenna cover comprises a surface formed outside the antenna in a conical fashion, with the surface of the antenna cover preferably being fluid repellent.

4. The fill level measuring device of claim 1, wherein the antenna cover represents an antenna lens for bundling the microwave radiation.

5. The fill level measuring device of claim 2, wherein the resistance heater is arranged extending meandering at or in the antenna cover.

6. The fill level measuring device of claim 2, wherein the resistance heater comprises longitudinal sections arranged parallel in reference to each other, which are connected to each other at their ends via lateral sections, with the longitudinal sections extending straight-lined and show at least twice the length, preferably four times the length of the lateral sections.

7. The fill level measuring device of claim 6, wherein the resistance heater is aligned in reference to the antenna such that the longitudinal sections of the resistance heater are arranged perpendicular in reference to the polarization of the microwave radiation.

8. The fill level measuring device of claim 1, wherein the antenna is made from a metal coated plastic.

9. The fill level measuring device of claim 1, wherein the antenna cover is made from a non-conductive plastic, preferably PTFE.

10. The fill level measuring device of claim 1, wherein the antenna cover is fastened with a metal ring at the end of the antenna, preferably via a screw connection.

11. The fill level measuring device of claim 1, wherein the fill level measuring device comprises a device flange for sealing the interior chamber of the container from an exterior chamber of the container, with the device flange comprising a bore channel with a first end and a second end, preferably in the form of a bore tunnel, with its first end being open and with its second end being closed in a sealing fashion by a screw-connected cover fastened at the device flange, which shows an electric passage.

12. The fill level measuring device of claim 2, wherein a supply line is guided through a sealing passage which separates the atmosphere inside the antenna from the atmosphere surrounding the antenna, with the sealing passage being arranged preferably at the metal ring.

13. The fill level measuring device of claim 2, wherein a supply line is arranged in the bore channel and electrically connected to the sealing screw connection or is guided through the sealing screw connection.

14. The fill level measuring device of claim 13, further comprising a control unit for controlling the heating device, which is electrically connected to the supply line.

15. The fill level measuring device of claim 2, wherein the resistance heater is molded with the antenna cover or is adhered on the antenna cover, with the resistance heater preferably representing a resistance wire.

16. The fill level measuring device of claim 1, wherein the antenna is a horn antenna or a parabolic antenna.

17. The fill level measuring device of claim 10, wherein the metal ring is a part of the device flange or is embodied in one piece with said device flange.

18. The fill level measuring device of claim 14, wherein the antenna cover comprises a temperature measuring means and/or a humidity measuring means and/or a means for detecting adhering substances on the antenna cover, and the control unit using the measurements provided by the temperature measuring means and/or the humidity measuring means and/or the means for detecting substances adhering to control the energy to be supplied to the heating device.

19. The fill level measuring device of claim 1, wherein energy is supplied to the heating in a time-controlled fashion.

20. The fill level measuring device of claim 1, wherein the capacity of the energy supplied to the heating device is determined depending on the temperature measured at the antenna cover and/or depending on the humidity measured at the antenna cover and/or depending on the components adhering at the antenna cover and/or depending on other parameters.
